(19) United States
(12) Patent Application Publication
(10) Pub. No.: US 2010/0250231 A1
(43) Pub. Date: Sep. 30, 2010

(54) Mouthpiece with sound reducer to enhance language translation

(75) Inventor: Irving Almagro, Irvine, CA (US)

Correspondence Address: Irving Almagro, 2906 Simplicity, Irvine, CA, 92620, US

(73) Assignee: VOICE MUFFLER CORPORATION, Irvine, CA (US)

(21) Appl. No.: 12/719,004

(22) Filed: Mar. 7, 2010

Related U.S. Application Data
(60) Provisional application No. 61/158,357, filed on Mar. 7, 2009.

(51) Int. Cl. G06F 17/28

(52) U.S. Cl. 704/2

(57) ABSTRACT

A language translation device having a contour shaped housing that covers the mouth area of a user thereby substantially preventing said user's speech from being heard by a person who speaks a different language thus enhancing realtime speech-to-speech interpretation. Said device comprises a microphone to capture a user's speech that is transmitted to a language processing system and a loudspeaker to output a received translated speech for said different language person to hear.

### RELATED APPLICATION

This application claims priority date under 35 U.S.C. sctn. 119(e) from the following U.S. provisional application: Application Ser. No. 61/158,357, titled “Wireless Voice Muffled Mouthpiece for Language Translation,” filed on Mar. 7, 2009.

### BACKGROUND OF THE INVENTION

The present invention relates generally to interlingual communications, passive and/or active noise reduction, military headgear components, and hands-free headsets and more particularly to realtime wireless two-way speech-to-speech translation devices which are essential to the military or native citizens to communicate with people who speak a different language.

Ambient noise or vocal noise is the undesirable soundwave emitted when a person speaks. The reporting device or Stenomask that was patented over 20 years ago in Gore, U.S. Pat. No. 4,129,754 provided a viable solution in reducing undesirable sounds or noise when using a microphone in ruckus adverse environments such as courtrooms. The voice muffled device has been found to be an excellent apparatus for speech recognition systems due to: 1) its microphone is positioned at a constant distance from the speaker's mouth which is an essential criterion in achieving a high rate of recognition success, and 2) it stopped outside noise from being captured by the microphone thereby reducing signal distortion. However, since the effectiveness of the device necessitated that it be pressed firmly against a user's face, such effortful task would be seriously lacking in convenience and therefore undesirable. As a minimum consideration for attaining an effective interlingual communication, a device that can block an adequate amount of a speaker's unwanted voice would greatly improve the intelligibility of a translated speech. A voice muffling contraption that is less cumbersome is one of the features that the present invention seeks to achieve. By muffling the user's speech, a more intelligible conversation with a foreigner will be accomplished since there will be less of the user's speech that can jumble with the translated speech. An active noise canceling capability of the invention would be the most preferred method of reducing unwanted vocal noise.

There are currently numerous handheld military devices which translate languages such as the Phraselator made by Voxtec and the Lynx by Secure Communication Systems. Unfortunately, these devices are typically limited to small sets of vocabularies due to the fact that they rely on internal memory chips for storage. Increasing the memory capacity to accommodate larger vocabularies would involve making these handheld devices bigger physically, thereby increasing their size, weight and power requirement. A better approach is to use a hands-free solution whereby the vocabularies can be stored in a remote file server then use an integrated transceiver to send a speech to be translated and retrieve the translated speech.

Bluetooth wireless technology is a short-range communications technology intended to replace the cables connecting portable and/or fixed devices while maintaining high levels of security. WiMAX, LTE and similar broadband technology provide long range telecommunications for portable devices. WiFi and Wireless USB technology facilitate the telecommunications of voice and data signals to computer systems. UHF, VHF, Microwave and other radio transceiver technologies convert and reproduce audio and digital signals into radio waves to facilitate telecommunications.

Thus, embedding a microphone inside a sound muffler, have the user's speech converted to a desired language and then output the translated speech to a loudspeaker for a foreigner to hear; and still further, affix an external microphone on said device to capture a foreigner's speech, convert said speech to the user's language and output it to an earphone for the user to hear—such arrangement would provide a user a convenient, quieter, and effective interlingual communications device. Further, providing a translation device with a transceiver capability allows a human translator to be situated thousands of miles away from areas of conflict thereby reducing fear and intimidation from nefarious elements of society.

### SUMMARY OF THE INVENTION

In an exemplary embodiment, the present invention comprises a mouthpiece assembly with sound reducing components defining a housing that generally contours about a user's mouth area and can be swiveled to cover said user's mouth area when in use thereby confining or reducing vocal noise, said mouthpiece further comprising an internal microphone to capture the user's speech, an external microphone to capture a foreigner's speech, and an external loudspeaker for outputting the user's translated speech to be heard by said foreigner.

In another exemplary embodiment, the present invention comprises: a headgear's chin cup assembly; and a mouthpiece assembly that mounts onto said chin cup assembly having some noise reducing components defining a concave-shaped housing that contours about a user's mouth area and swivels up or down, further comprising an internal microphone to capture the user's speech, an external microphone to capture a foreigner's speech, and an external loudspeaker for outputting the translated speech to be heard by a foreigner.

In another exemplary embodiment, the present invention comprises: a headset assembly; and a mouthpiece assembly that mounts onto said chin cup assembly having some noise reducing components defining a concave-shaped housing that contours about a user's mouth area and swivels sideways, further comprising an internal microphone to capture the user's speech, an external microphone to capture a foreigner's speech, and an external loudspeaker for outputting the translated speech to be heard by a foreigner.

In another exemplary embodiment, the present invention comprises: a headgear's chin cup assembly; a mouthpiece assembly that mounts onto said chin cup assembly having some noise reducing components defining a concave-shaped housing that contours about a user's mouth area and swivels up or down, further comprising an internal microphone to capture the user's speech, an external microphone to capture a foreigner's speech, and an external loudspeaker for outputting the translated speech to be heard by a foreigner; and a language translation system further comprising an integrated language translation unit to translate speech automatically and an earphone to allow the user to hear a foreigner's translated speech.

In another exemplary embodiment, the present invention comprises: a headgear's chin cup assembly; a mouthpiece assembly that mounts onto said chin cup assembly having some noise reducing components defining a concave-shaped housing that contours about a user's mouth area and swivels up or down, further comprising an internal microphone to capture the user's speech, an external microphone to capture a foreigner's speech, and an external loudspeaker for outputting the translated speech for a foreigner to hear; and a language translation system further comprising a transceiver to transmit untranslated speech and receive translated speech, and an earphone to allow the user to hear a foreigner's translated speech.

In another exemplary embodiment, the present invention comprises: a headgear's chin cup assembly; a mouthpiece assembly that mounts onto said chin cup assembly having some noise reducing components defining a concave-shaped housing that contours about a user's mouth area and swivels up or down, further comprising an internal microphone to capture the user's speech, an external microphone to capture a foreigner's speech, an external loudspeaker for outputting the translated speech to be heard by a foreigner, and a video camera component to capture a foreigner's gestures; and a language translation system further comprising an integrated language translation unit to translate speech automatically or a transceiver system that can link to a remote translation facility for transmitting untranslated speech and receiving translated speech, and an earphone to allow the user to hear a foreigner's translated speech.

### OBJECTS OF THE INVENTION

It is therefore an object of the invention to provide a rotatable mouthpiece that can dampen unwanted vocal sounds from a user speaking a certain language; capture the user's speech by means of a microphone; translate said speech into a language intended for a foreigner by utilizing an integrated speech processing system or a transceiver that can link to a remote translation facility connected wirelessly by an integrated transceiver; and convert the translated speech into an audible sound outputted by the external loudspeaker that can be heard by the intended foreigner. Further, it is an object of the invention to allow the speech of the foreigner to be captured by the microphone located on the external part of the device; translate said speech into a user's language utilizing an integrated speech processing system or a remote translation facility linked by means an integrated transceiver; and output the translated speech to the device's earphone to be heard by the user.

A further object of the invention is to provide a hands-free voice muffled translation device for a helmet or headset that can include or complement an existing video camera and/or a display system, such as those already implemented on some military helmets, to improve the translation effectiveness.

A further object of the invention is to provide a hands-free voice muffled translation device for a helmet or headset that can effectively eliminate unwanted sounds by incorporating a removable sound absorbing interior housing or baffle component.

A further object of the invention is to provide a hands-free voice muffled translation device for a helmet or headset that can utilize a user's voice to adjust the volume of the loudspeaker output and/or automatically adjust the volume of the loudspeaker output depending on the audio intensity of the user's voice.

A further object of the invention is to provide a hands-free voice muffled translation device for a helmet or headset that allows the mouthpiece to be detached easily from the chin cup assembly by using voice to activate a relay that disengages a latch securing said mouthpiece.

A further object of the invention is to provide a hands-free voice muffled translation device for a helmet or headset that can utilize active noise canceling system to muffle a user's voice.

### BRIEF DESCRIPTION OF THE DRAWINGS

FIG. 1 is a front perspective view of an embodiment of the invention.

FIG. 2 is a rear perspective view of an embodiment of the invention.

FIG. 3 is a front elevational view of an embodiment of the invention.

FIG. 4 is a rear elevational view of an embodiment of the invention.

FIG. 5 is a front elevational view of an embodiment of the invention showing the major internal components after the protective material or cover has been removed.

FIG. 6 is a front elevational view of a mouthpiece assembly showing the major internal components of an active noise canceling adaptation after the protective material or cover has been removed.

FIG. 7 is a front elevational view of a mouthpiece assembly of an active noise canceling embodiment of the invention having a protective cover.

FIG. 8 is a top plan view of an embodiment of the invention.

FIG. 9 is a top sectional view of an embodiment of the invention.

FIG. 10 is a side elevational view of an embodiment of the invention.

FIG. 11 is a side sectional view of an embodiment of the invention.

FIG. 12 is a perspective view of an embodiment of the invention showing the mouthpiece assembly in a closed or in-use position.

FIG. 13 is a perspective view of an embodiment of the invention showing the mouthpiece assembly in an open or not-in-use position.

FIG. 14 is a front elevational view of a chin cup assembly of an embodiment of the invention.

FIG. 15 is a rear elevational view of a chin cup assembly of an embodiment of the invention.

FIG. 16 is a top plan view of a chin cup assembly for a helmet embodiment of the invention.

FIG. 17 is a side elevational view of a chin cup assembly for a helmet embodiment of the invention.

FIG. 18 is a side sectional view of a chin cup assembly for a helmet embodiment of the invention.

FIG. 19 is a front perspective view of a chin cup assembly for a helmet embodiment of the invention.

FIG. 20 is a rear perspective view of a chin cup assembly for a helmet embodiment of the invention.

FIG. 21 is a front elevational view of a mouthpiece assembly for a helmet embodiment of the invention.

FIG. 22 is a front elevational view of a mouthpiece assembly for a helmet embodiment of the invention shown with a protective cover removed.

FIG. 23 is a rear elevational view of a mouthpiece assembly for a helmet embodiment of the invention.

FIG. 24 is a top plan view of a mouthpiece assembly for a helmet embodiment of the invention.

FIG. 25 is a side elevational view of a mouthpiece assembly for a helmet embodiment of the invention.

FIG. 26 is a front perspective view of a mouthpiece assembly for a helmet embodiment of the invention.

FIG. 27 is a rear perspective view of a mouthpiece assembly for a helmet embodiment of the invention.

FIG. 28 is an exploded front view of a support arm assembly of a mouthpiece assembly for a helmet embodiment of the invention.

FIG. 29 is an exploded side view of a support arm assembly of a mouthpiece assembly for a helmet embodiment of the invention.

FIG. 30 is an exploded front perspective view of a support arm assembly of a mouthpiece assembly for a helmet embodiment of the invention.

FIG. 31 is a perspective view of a helmet embodiment of the invention showing a language translation assembly.

FIG. 32 is a front elevational view of another embodiment of the invention showing a chin cup assembly with a volume control potentiometer and an external microphone.

FIG. 33 is a front elevational view of another embodiment of the invention showing a chin cup assembly with a connector assembly and an external microphone.

FIG. 34 is pictorial representation of how a helmeted soldier would use the speech translation function of the invention.

FIG. 35 is pictorial representation of how a helmeted soldier would not use the speech translation function of the invention.

FIG. 36 is pictorial representation showing a helmeted soldier speaking to a foreigner in accordance with an embodiment of the invention.

FIG. 37 is pictorial representation showing a foreigner speaking to a helmeted soldier in accordance with an embodiment of the invention.

FIG. 38 is pictorial representation showing a helmeted soldier speaking to a fellow soldier in accordance with an embodiment of the invention.

FIG. 39 is a perspective view of a headset embodiment of the invention showing the major components comprising a headband assembly with a pivot mechanism, a mouthpiece assembly, and a translator assembly.

FIG. 40 is a perspective view of a headset embodiment of the invention showing the major components comprising a headband assembly with a flexible hollow boom, a mouthpiece assembly, and a translator assembly.

FIG. 41 is a perspective view of a headband assembly having a pivot mechanism in accordance with a headset embodiment of the invention.

FIG. 42 is a perspective view of a headband assembly having a flexible hollow boom in accordance with a headset embodiment of the invention.

FIG. 43 is a front elevational view of a mouthpiece assembly having a pivot mechanism in accordance with a headset embodiment of the invention.

FIG. 44 is a front elevational view of a mouthpiece assembly having a pivot mechanism showing the major internal components after the protective cover has been removed in accordance with a headset embodiment of the invention.

FIG. 45 is a rear elevational view of a mouthpiece assembly having a pivot mechanism in accordance with a headset embodiment of the invention.

FIG. 46 is a top plan view of a mouthpiece assembly having a pivot mechanism in accordance with a headset embodiment of the invention.

FIG. 47 is a side view of a mouthpiece assembly having a pivot mechanism in accordance with a headset embodiment of the invention.

FIG. 48 is a front elevational view of a mouthpiece assembly linked to a flexible hollow boom showing the major internal components in accordance with a headset embodiment of the invention.

FIG. 49 is a rear elevational view of a mouthpiece assembly linked to a flexible hollow boom in accordance with a headset embodiment of the invention.

FIG. 50 is a top plan view of a mouthpiece assembly linked to a flexible hollow boom in accordance with a headset embodiment of the invention.

FIG. 51 is a side elevational view of a mouthpiece assembly linked to a flexible hollow boom in accordance with a headset embodiment of the invention.

FIG. 52 is a front elevational view of a mouthpiece assembly linked to a flexible hollow boom in accordance with a headset embodiment of the invention.

FIG. 53 is a front perspective view of a detachable language translation component for the mouthpiece assembly having a pivot mechanism in accordance with a headset embodiment of the invention.

FIG. 54 is a front perspective view of a detachable language translation component for the mouthpiece assembly linked to a flexible hollow boom in accordance with a headset embodiment of the invention.

FIG. 55 is an exploded side view of an earpiece component for a headband assembly having a flexible boom showing the major internal elements and cable routes in accordance with a headset embodiment of the invention.

FIG. 56 is a pictorial representation of a first side of a user using a headset embodiment of the invention whereby the mouthpiece assembly is seen in a closed position, covering the mouth area of the user in accordance with a headset embodiment of the invention.

FIG. 57 is a pictorial representation of a second side of a user using a headset embodiment of the invention whereby the mouthpiece assembly is seen a closed position, covering the mouth area of the user.

FIG. 58 is a pictorial representation of a first side of a user not using a headset embodiment of the invention whereby the mouthpiece assembly is seen in an open position, not covering the mouth area of the user.

FIG. 59 is a pictorial representation of a second side of a user not using a headset embodiment of the invention whereby the mouthpiece assembly is seen in an open position, not covering the mouth area.

FIG. 60 is a pictorial representation of a user using a headset embodiment of the invention.

FIG. 61 is a pictorial representation of a user not using a headset embodiment of the invention.

FIG. 62 is a pictorial representation of a user temporarily placing a headset embodiment of the invention in a storage or standby position.

FIG. 63 is a pictorial representation showing a user speaking to a foreigner in accordance with an embodiment of the invention.

FIG. 64 is a pictorial representation showing a foreigner speaking to a user in accordance with an embodiment of the invention.

FIG. 65 is a pictorial representation showing a user speaking to a fellow native speaker in accordance with an embodiment of the invention.

FIG. 66 is a flowchart diagram summarizing a speech-to-speech language translation process using an integrated speech processing system in accordance with an embodiment of the invention.

FIG. 67 is a flowchart diagram summarizing a speech-to-speech language translation process using an integrated wireless transceiver system in accordance with an embodiment of the invention.

FIG. 68 is a flowchart diagram summarizing an active noise cancelling process using in accordance with an embodiment of the invention.

FIG. 69 is a diagram of a typical operational mode of the device in accordance with a helmet embodiment of the invention showing typical short range communication links.

FIG. 70 is a diagram of a typical operational mode of the device in accordance with a helmet embodiment of the invention showing some short and long range communication links.

FIG. 71 is a diagram of a typical operational mode of the device in accordance with a headset embodiment of the invention showing typical short range communication links.

FIG. 72 is a diagram of a typical operational mode of the device in accordance with a headset embodiment of the invention showing some short and long range communication links.

FIG. 73 is a pictorial representation showing a correlation between the device and a user in accordance with an embodiment of the invention.

### DETAILED DESCRIPTION OF THE PREFERRED EMBODIMENT

As used herein, the term “user,” or “first person,” is intended but not limited, to generally refer to a person who is operating or manipulating or holding or grasping, or speaking to, or a combination thereof, a microphonic device having a purpose of effecting a translation of his or her speech to an intended language. Generally, said user is wearing a military style combat helmet with chinstraps in place speaking his native language into the microphonic device.

As used herein, the term “foreigner,” or “second person,” is intended but not limited, to generally refer to someone who speaks a language that is different from a user's native language. A foreigner can also be a person who is not operating nor manipulating nor holding nor grasping, nor a combination thereof, but may speak in his native or foreign language to a user's device.

As used herein, the term “interpreter,” or “language translator,” is intended but not limited, to generally refer to someone who speaks a language that is different from a user's native language. An interpreter can also be a person who is not operating nor manipulating nor holding nor grasping, nor a combination thereof, but may speak in his native or foreign language to a user's device.

As used herein, the term “housing” is intended but not limited, to generally refer to a metallic or non-metallic or a combination of both, protective cover, casing, case, shell or enclosure designed to contain, enclose or support another housing, mechanical, electrical, electronic components, and/or any combination thereof. It can be homogeneous, heterogeneous, multi-layered, multi-bodied, multi-frame, multi-colored and/or any combination thereof. It may be rigid, semi-rigid, flexible, supple, and/or a combination thereof. It may also have properties such as sound absorbing, soundproofing, sound muffling, noise reducing, sound blocking, sound baffling, sound distorting, anti-bacterial, germicidal, anti-viral, anti-odor, electromagnetic shielding, radiation shielding, and/or a combination thereof.

As used herein, the term “language translation system,” or “language processing unit,” or “language translator,” or “translator,” or “language translation unit,” or “personal translator,” is intended but not limited, to generally refer to a standalone computer system having electronic and electrical components such as a voice recognition circuit, text-to-speech converter, CODEC, DAC, Advanced RISC Machine (ARM) chip, analog and/or digital computer, speech application processor, memory, firmware, sound quality optimizer, input/output interface circuitry, power supply, battery, battery charging circuit, timer, test and monitoring circuitry, amplifier, signal inverter circuit, video circuit, digital and analog processors, signal conditioners, analog and digital amplifiers, automatic volume or gain control circuitry, anti-noise signal generating circuits, other associated mechanical, electronic and electrical components, and/or any combination thereof, the main function of which is: to effect a speech-to-speech language translation; to condition and/or amplify analog and/or digital signals; and/or to output translated speech signals. Further, software programs such as language translation software, voice-recognition software, text-to-speech software, voice-enabling software, voice-control software, and/or a combination thereof, can be part of the language translation system. An active noise canceling circuitry can also be integrated into the language translator. It should be further understood that it is a common practice in the electronics industry to use expansion slots, external memories, adapters, sockets, connectors, and/or any combination thereof, with the goal of providing robustness, enhancement capability, expansion capability, and natural progressive extensibilty of the language processor. Examples of such products include Solid State Drives, flash drives, firmware ROMs, USB drives, I/O cards and peripherals. As well, some components of the transceiver do not necessarily have to stay enclosed within the module for it to qualify as a transceiver. For example, to lengthen the language translator's usage, a battery pack can be added, and to extend its vocabularies, more memory or a hard drive or solid state drive can be added, externally. Other examples include SIM cards, SD memory cards, CF memory cards, amplifiers, firmware ROMs, etc. Further, due to the rapid advances in the semiconductor industry with regards to modularization, it is further understood that more and more discrete components are being integrated and miniaturized therein. For example, most PC practitioners refer to the CPU as just the computer chip, and related supporting circuits such as a digital communications controllers I/O controller, firmware ROM, timing circuits, cache controller, were considered separate or discrete components. Nowadays, the CPU is composed of all these formerly discrete components that have been integrated or modularized into a single chip or module. It is therefore understood that the terms mentioned above also encompass all advancements related to the computer processing technology such as miniaturization, integration and modularization of discrete components.

As used herein, the term “transceiver,” or “personal transceiver,” or “transceiver system,” or “transceiver unit,” or “transceiver module,” is intended but not limited, to generally refer to a full-duplex, wireless or radio frequency system having electronic components and circuitry such as a transmitter, receiver, CODEC, DAC, Advanced RISC Machine (ARM) CPU, application processor, memory, sound quality optimizer, telephone number dialing circuitry, antenna, power supply, battery, battery charger, timer, test and monitoring circuitry, amplifier, video circuit, digital and analog processors, AF or RF signal conditioners, automatic volume or gain control circuitry, active noise cancelation electronics, other associated mechanical, electronic and electrical components, and/or any combination thereof, the main function of which is: to transmit analog and/or digital signals; or to receive analog and/or digital signals; or a combination thereof. The transmission and reception mode of a transceiver can also be simplex, half-duplex or multiplex. As a Personal Computer (PC) may refer to a computer system comprising of dual processors; peripherals such as keyboards, monitors, sound cards having microphone input and loudspeaker outputs, amplifiers; and software, a personal transceiver may likewise refer to a combination of dual channel transceiver chips with peripherals, amplifiers and software to become functional. Further, software programs such as voice recognition, speech-to-text, text-to-speech, active noise cancelation, and/or a combination thereof, can be part of a transceiver for it to become functional. In a language translation adaptation, an image or video processor may also be integrated into the transceiver to allow a remotely located interpreter get a better grasp of the user's surrounding, thereby effecting a more accurate translation. Further, in an active noise cancellation adaptation, the transceiver can additionally comprise of a microphone, amplifier and loudspeaker components to reduce undesirable soundwaves by feeding back a 180 degree phased signal of the original soundwaves to cancel out the original soundwaves. It should be further understood that it is a common practice in the electronics industry to use expansion slots, adapters, sockets, connectors, and/or any combination thereof, with the goal of providing robustness and extensibilty of the transceiver by adding enhancement capabilities and new functionalities of their hardware products. Some components of the transceiver do not necessarily have to stay enclosed within the module for it to qualify as a transceiver. For example, to lengthen the transceiver's usage, a battery pack can be added, and to extend its range a RF amplifier and longer antenna can be added, externally. Other examples include SIM cards, SD memory cards, CF memory cards, amplifiers, firmware ROMs, etc. These additional components are associated with the transmitting and receiving functions and are therefore considered integral parts of the “transceiver” and thus may not need to be specified as separate components. Further, due to the rapid advances in the semiconductor industry with regards to miniaturization, it is further understood that more and more discrete components are being integrated and made modular therein. For example, previous PC practitioners refer to the CPU as just the computer chip, and related supporting circuits such as a digital communications controllers I/O controller, firmware ROM, timing circuits, cache controller, were considered separate or discrete components. Nowadays, however, the CPU refers to of all these formerly discrete components as part of the computer chip integrated or modularized into a single chip or module. Similarly, the transceiver has been constantly transitioned into a modularized structure and therefore it is understood that the term also encompasses, but not limited, to the integration and modularization of discrete components that relate to the function of transmitting and/or receiving analog/digital signals. Further, wireless base stations are also considered as transceivers since their main function is to transmit and receive data in addition to signal processing and conditioning.

As used herein, the term “multifunction key,” or “multi-key” is intended but not limited, to generally refer to a push button switch which allows the invention to be activated, powered up or powered down, pair with compatible wireless devices, run a self-test or bootup routine, as well as other tasks associated with the efficient functioning and high performance of the transceiver system. The transceiver multi-key starts up and maintains the process of getting power to the transceiver from the power source, typically a battery, or starting a standby timer which powers down the transceiver after a set period of time, a function also known as auto-shutoff used for conserving the device's battery. This key can also be used to power down the device when the user depresses it for a few seconds. Additionally, this key may be associated or integrated with small indicator lamps which provide status information of the wireless device. It is understood that new functions are continually added to this component to enhance the transceiver's capabilities, so implementing these enhancements on the current invention would be embraced and considered as a normal progression or transition of its technology. A power switch used for powering up, powering down, timed shutdown, or placing a personal translator on a standby mode, may also be called a multi-key.

As used herein, the term “microphone” is intended but not limited, to generally refer to a device or an instrument that converts sound waves into an electric current, usually fed into a sound processor, an amplifier, a recorder, or a broadcast transmitter. It can also be an instrument used to capture audio waves from a user of an electronic device such as a wireless language translator, a cellphone, a mobile phone, a wireless headset and other speech input devices. A microphone can also be any type depending upon the manufacturer's or the user's preference—whether it be sound quality, noise canceling capability, weight and/or cost consideration, size, ruggedness, and/or a combination thereof. It is understood that the microphone technology is constantly evolving and improving which therefore makes it very conceivable that the microphone used in the present invention may adopt all the aforementioned enhancements and/or improvements thereof.

As used herein, the term “foam,” or “liner,” is intended but not limited, to generally refer to a piece of substance that can have properties such as germicidal, anti-bacterial, antibiotic, anti-microbial, anti-odor, sound absorbing, soundproofing, soundblocking, noise reducing, wind screening, adhesive, disposable, washable, and/or any combination thereof.

As used herein, the term “earphone,” or “earbud,” or “headphone,” or “in-ear headphone,” is intended but not limited, to generally refer to a device or an instrument that converts electrical signals into audible waves or sounds, of a size that is generally small, adjustable and lightweight, which allows a typical person to wear said device on or in his ear. It can have features such as high sound quality, automatic volume control, enhanced equalizer, noise canceling capability, lightweight, replaceable cushion cover, wireless, cordless, miniaturized, rugged, and/or a combination thereof. Considering that the earphone technology is constantly evolving and improving, it is therefore understandable that the earphone to be used in the present invention will also adapt to any advancements or improvements of said earphone thereof.

As used herein, the term “battery”, or “battery pack”, is intended but not limited, to generally refer to a direct-current voltage source made up of one or more units that convert chemical, thermal, nuclear, mechanical or solar energy into electrical energy. It can be disposable, rechargeable type and/or a combination thereof. A power source such as an AC adapter can also be referred to as battery. It is understood that the battery technology is constantly evolving and improving, therefore the type or kind of battery that the present invention may adopt will depend on the preference of an application or manufacturer.

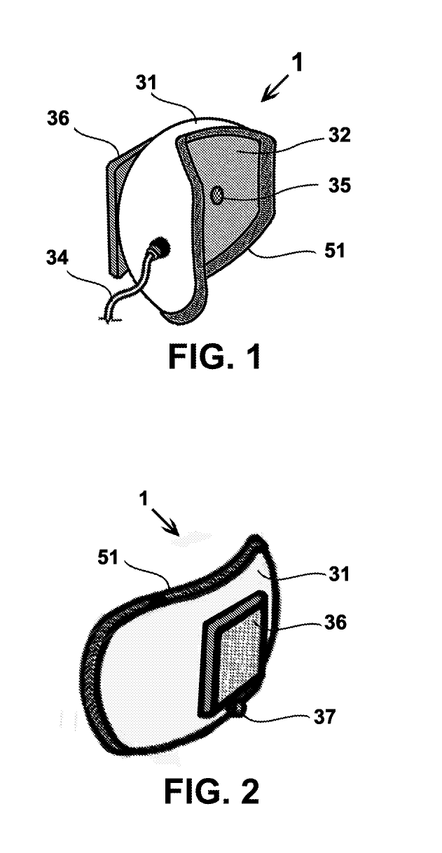

FIGS. 1 (a front perspective view) and 2 (a rear perspective view) are views of the present invention, seen as general reference 1, comprising a rigid or semi-rigid housing 31 having a concave shape conforming to the contour of a user's mouth area further comprising an internal microphone 35 to accept a user's speech, a loudspeaker 36 to output the translated speech in an audible volume that is of optimal intensity that a foreigner can hear intelligibly, a protective foam or liner or sound absorbing material or combination thereof 32 to reduce the noise emitted by a user speaking into the invention 1, an external microphone 37 positioned or directed towards a foreigner to capture said foreigner's speech for translation into the user's language, and a cable or wiring harness 34 to connect the electrical/electronic components to a translation assembly or sound processor assembly 40. A flexible absorbing material or cushion 51 affixed to the rim portion of said housing 31 may be implemented on said invention 1 to provide comfort to the user.

A wiring hole 34a is provided for cable 34 to pass the wires of the internal microphone 35, loudspeaker 36, and the external microphone 37 through the housing 31 whereas wiring hole 37a allows for the wires of the microphone 37 to pass through. A suitable opening, popscreen, or mesh screen 35a may be implemented to allow sound to be received by the internal microphone 35 effectively. Alternatively, the material 32 may be positioned between the internal microphone 36 and the housing 31, allowing the front of said microphone to be free from any obstruction. To reduce unwanted pressure build-up inside the mouthpiece 30 during its operation, an air vent, preferably of the one-way type, may be located on or inside the housing 31.

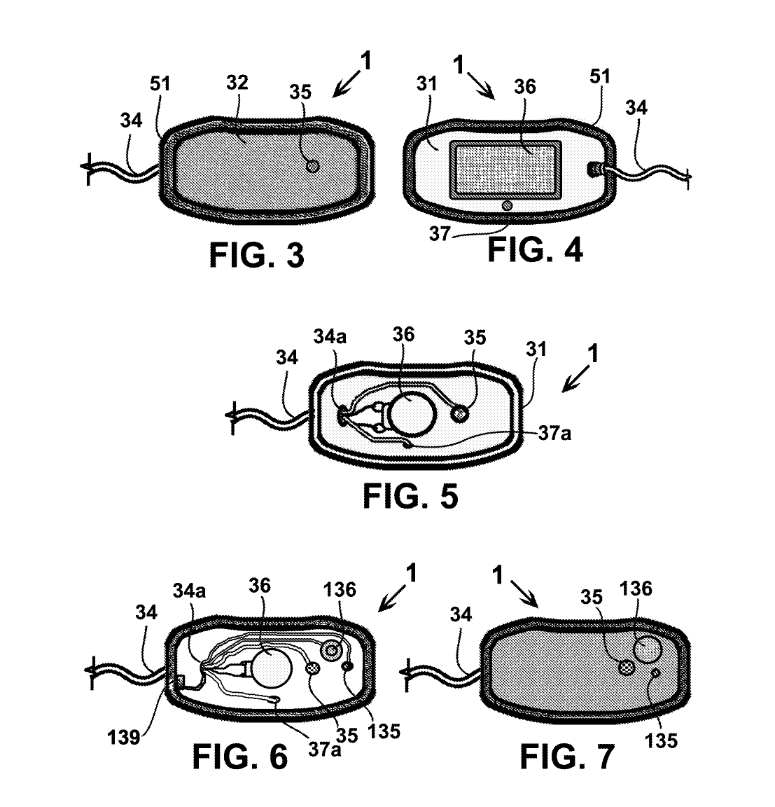

FIG. 3 shows the front elevational view of the invention 1 shown with the protective foam cover 32 in place. FIG. 4 shows the rear view and FIG. 5 shows the invention 1 without the protective foam cover 32.

FIGS. 6 (with the protective foam 32 removed) and 7 show another embodiment of invention 1 generally comprising of the components described in the two previous paragraphs plus some electronic components that can effect active noise cancellation such as a microphone 135 and a loudspeaker 136, whereby the microphone 135 captures the vocal noise signal which is inverted and fed to the loudspeaker 136 that produces the soundwaves to cancel out the vocal noise. A corresponding noise cancellation electronic circuitry (integrated in the language translation assembly 40) processes and generates the amplified anti-noise signals. Alternatively, the anti-noise microphone 135 can be eliminated because the internal microphone 35 can be allowed to have a dual use, i.e., it can provide the audio signal for language translation and also can provide the signal for generating the anti-noise soundwaves. A sensor 139 that detects the status of invention 1 whether it is in-use or not may also be implemented and located in a suitable location on housing 31.

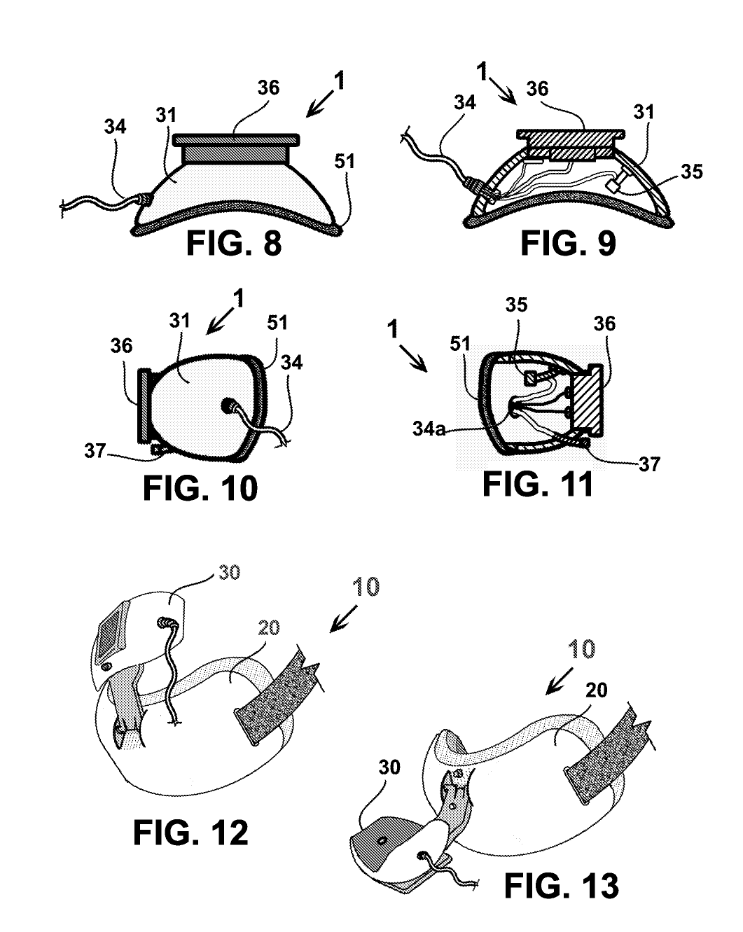

FIG. 8 shows the top plan view of the invention 1. The succeeding views demonstrate further the arrangements of the general components of the invention 1 starting with the top sectional view (FIG. 9), the side view (FIG. 10), and the side sectional view (FIG. 11).

FIGS. 12 and 13 show a helmet embodiment of the present invention 1, seen as general reference 10, comprising mainly of a chin cup assembly 20 and mouthpiece assembly 30 whereby the first figure demonstrates the invention 1 in an in-use or closed arrangement and the second figure showing the invention 1 in a not-in-use or open arrangement.

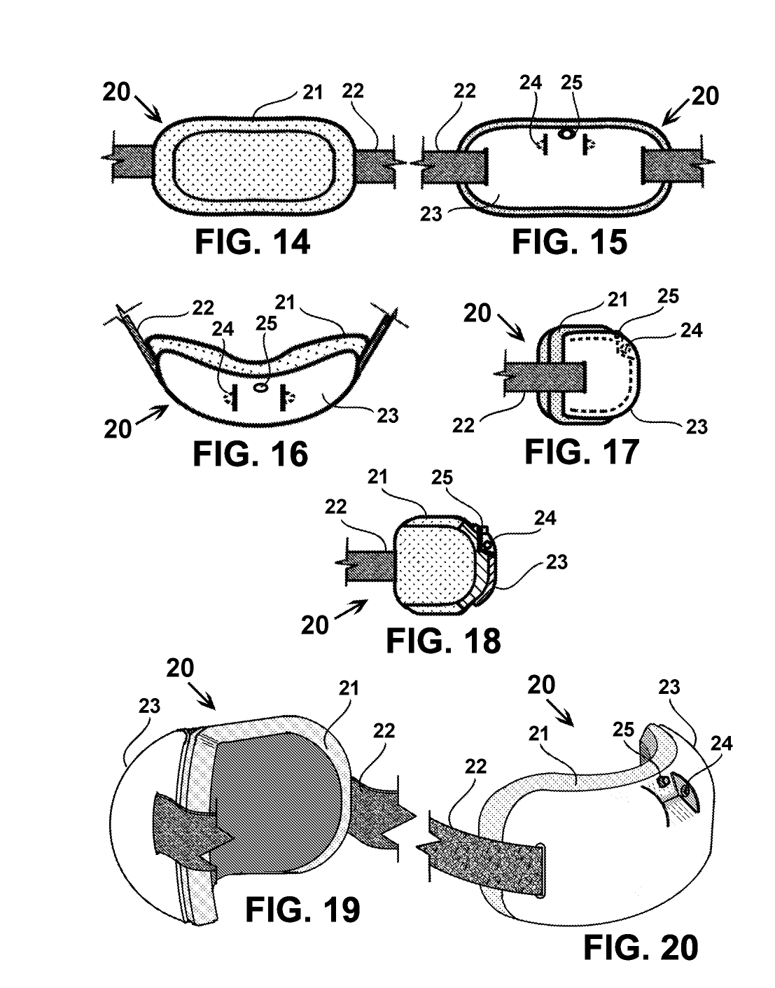

As shown in FIGS. 14-20, the chin cup assembly 20 is generally a retrofittable component and further comprises: a rigid housing or hard shell 23 having a contour shape conforming to a person's chin; a flexible impact absorbing material or cushion 21 affixed to the inner portion of said housing 23 to provide comfort to the user; a strap 22, which can be of the same material used in the existing equipment, to secure a helmet firmly on a user's head; and a securing hole 24 located on the exterior portion of the housing 23 to allow the mouthpiece arm support member 38 to rotate on its pivot member 33 while fully engaged and mounted onto the chin cup 20. Except for the securing hole 24, a prior art of said assembly 20 can be seen in most football headgear currently in use today. A fastener, clasp, or latch 25 may be implemented to lock or hold the mouthpiece arm support member 38 in place when the device 10 is in use. Further, a magnetic or electromagnetic latch mechanism 25 may be implemented as a fastener thereby firmly securing the mouthpiece 30 onto the chin cup 20.

FIG. 14 shows the front view of the chin cup assembly 20. The succeeding views demonstrate further the arrangements of the general components of the chin cup 20 starting with the rear view (FIG. 15), the top view (FIG. 16), the side view (FIG. 17), and the side sectional view (FIG. 18).

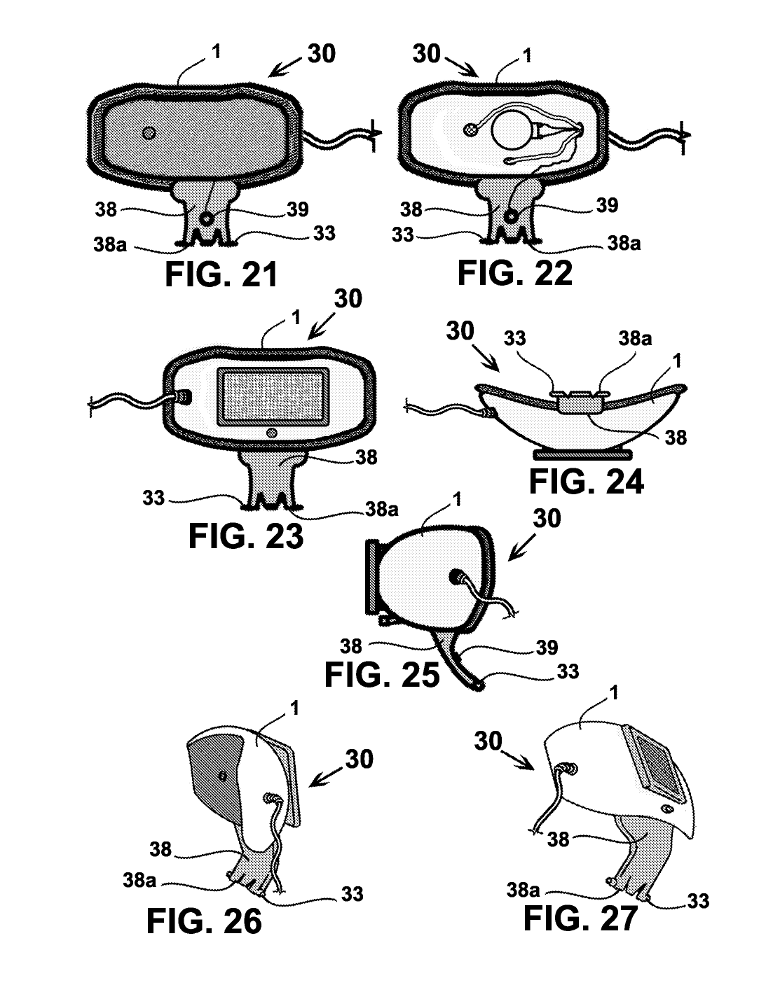

FIGS. 21-27 show a mouthpiece assembly 30 comprising said invention 1 and an arm support member 38 further comprising spaced apart members 38a, a pivot mechanism 33, and a fastener, clasp, detent or latch mechanism 39 to hold the mouthpiece 30 in place when it is being used. Pivot 33 mates with the securing hole 24 located on the chin cup 20 and allows for the mouthpiece 30 to swivel up or down while fully engaged and mounted onto said chin cup 20. The latch 39 corresponds to the fastener 25 located on the chin cup 20, which may also incorporate or be incorporated with a pushbutton switch or sensor component 39a whereby said sensor detects and performs functions such as causing the device 10 to get activated when it is in the closed or up position, and to deactive the device 10 when in the open or down position. A photodiode sensor, proximity sensor, or distance detector located inside the mouthpiece 30 may be implemented instead of the sensor component 39a. A sensor 139 that detects the status of invention 1 whether it is in-use or not may be implemented and located in a suitable location on housing 31. The internal microphone 35 in conjunction with voice command or similar software can also be used as part of a control component for automatically adjusting the output volume of loudspeaker 37. A firmware or software on the translator 41a he transceiver 41b can be implemented whereby the intensity of a user's voice can automatically adjust the volume of loudspeaker 37. FIG. 21 shows the front view of the mouthpiece assembly 30. The succeeding views demonstrate further the arrangements of the general components of the mouthpiece assembly 30 starting with the front view with the protective foam 32 removed (FIG. 22), the rear view (FIG. 23), the top view (FIG. 24), the side view (FIG. 25), the front perspective view (FIG. 26), and the rear perspective view (FIG. 27).

The elongated arm support member 38 is seen as generally having one end attached to the invention 1 and the other end having resilient spaced-apart members 38a, of which are two nibs or pins 33 located at the distal edges that define a pivotal axis. Each pivot pin 33 is arranged to mate with corresponding depressions or securing holes 24 located on the chin cup assembly 20. To join or mount the mouthpiece 30 to the chin cup 20, the areas closed to the spaced apart members 38a near the pins 33 are inwardly compressed, manipulating and then releasing them after pins 33 have aligned with their corresponding securing holes 24, establishing a secure mount for mouthpiece 30 onto chin cup 20. The pivotal axis defined by pins 33 allows the mouthpiece 30 to swivel up to cover the user's mouth area and swivel down to uncover the user's mouth area, depending on the desired application. To detach or disengage the mouthpiece 30 from the chin cup 20, the areas closed to the spaced apart members 32a near the pins 33 are inwardly compressed, withdrawing the pins 33 from their corresponding securing holes 24, and pulling or moving the mouthpiece 30 completely away from the chin cup 20. A suitable vent may also be incorporated on the mouthpiece 30 to lessen the sound pressures that may build up inside.

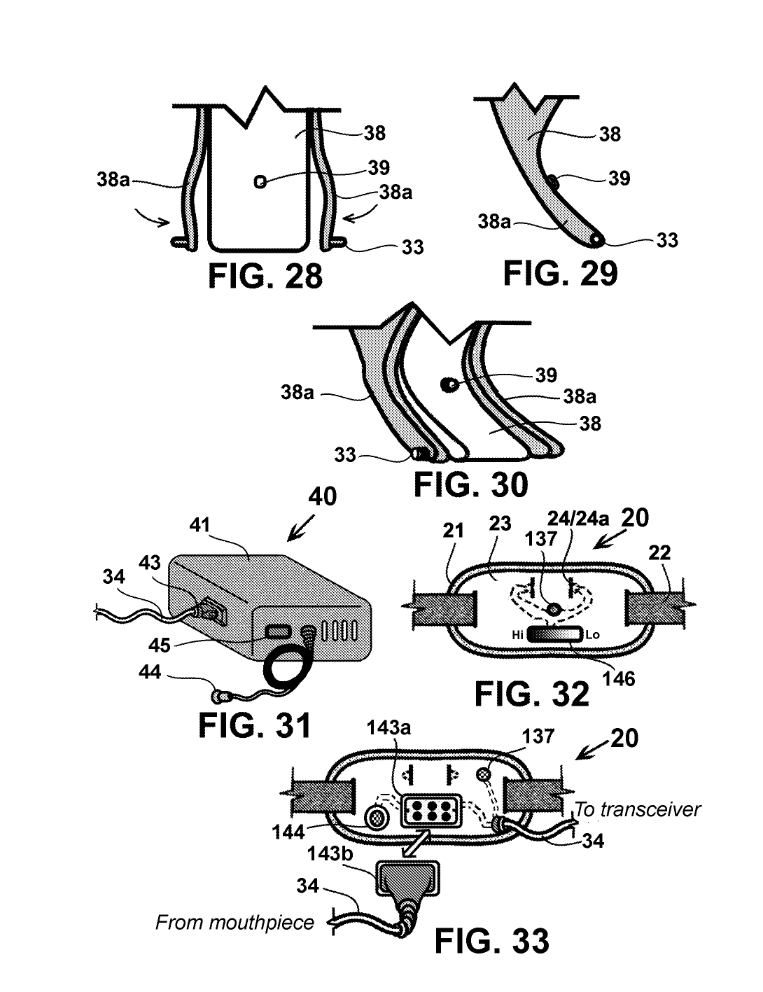

FIGS. 28 (front view), 29 (side view), and 30 (perspective view) illustrate exploded views of an alternative embodiment of the invention 10 whereby the spaced apart members 38a are defined by semi-bow shaped, elongated resilient plates having one of their ends attached to the sides of one end of the arm support 38 and the other end having pivot pins 33 located at the distal edges. A prior art example of such structure is found on a number of Mr. Coffee decanter lids such as the removable lid on the Mr. Coffee maker model number VB12. Alternatively, a voice-activated latch or relay mechanism may be incorporated into the mouthpiece 30 or chin cup assembly 20 to automatically disengage the mouthpiece 30 from the chin cup 20.

FIGS. 32 and 33 show the front views of alternative embodiments of the invention 10, showing a chin cup assembly 20 comprising a housing 23, a cushion 21, a strap 22, a securing hole 24, a potentiometer 146 for allowing manual adjustment of the volume of the loudspeaker 36, and/or an external microphone 137 positioned or directed towards a foreigner to capture said foreigner's speech for translation into the user's language and to enhance the quality of said captured speech. Microphone 137 can also be implemented to capture a user's speech when the mouthpiece 30 is inactive or detached from the chin cup 20 allowing the user to continue to have telecommunications capabilities. Electrical conductors or contacts 24a for the wires of said microphone 39 may be situated on the surfaces of securing holes 24 whereby said contacts 24a correspond to conductors located on the surfaces of pivot members 33 that connect to electrical and electronic components on the invention 1. A quick-connect adaptor 143a that corresponds to plug 143b allows the facilitation of the connection or disconnection of the electrical and electronic components of said assembly 20 and the mouthpiece 30 to the language translation assembly 40. Further, a video camera 144 may also be supplemented to the invention 10 and positioned on the exterior of assembly 30 to capture a foreigner's gestures, thereby enhancing the device's capabilities. It is understood, however, that most soldiers that are currently in combat in Iraq already have such a component as part of their gear and therefore in such aspect the translation assembly 40 will have in place the necessary circuitry and software to complement the existing hardware.

FIG. 31 shows a translation assembly 40 comprising a standalone (local) computerized language translator 41 that translates one or more languages into one or more targeted languages, an earphone 44 which allows a user to hear the translated language, and a switch or multi-key 45 to activate or deactivate 41. It can also have additional components such as an external battery, battery pack, or similar power source 42 to extend its power capacity and a cable connector, USB connector or quick-connect adaptor 43 to facilitate the connection or disconnection of the mouthpiece 30 electronics to the language translator 41. A compatible cordless earphone may also be used instead of corded earphone 44 for user convenience. The translated speech is normally generated by converting the user's speech into a desired language by the use of some software technologies such as automatic speech recognition (ASR), machine translation (MT), and text-to-speech synthesis (TTS) employing high speed computer systems. It is a preference of the invention 10 that the translator 41 to be used is fast and powerful, yet small and lightweight.

Alternatively, the translation assembly 40 can comprise an integrated transceiver 41 instead of an integrated standalone computerized translator 41 to allow for remote language translation. Using an integrated transceiver 41, a user's speech is transmitted to a remote language translation facility 80 that translates one or more languages into one or more targeted languages, either by human interpreters or by automated machine translators, and then receives the translated speech whereby said speech is conditioned to suitable signal levels that is intelligible to a foreigner. The transceiver 41 also receives a foreigner's speech and sends it to said remote language translation facility 80 whereby the translated speech is conditioned to suitable audio signal that is heard by the user of device 10. The transceiver 41 functionality of the device 10 allows a human translator to be situated thousands of miles away from areas of conflict, reducing fear and intimidation from combatants and terrorists. The transceiver 41 is generally optional if there is already a similar device that is being utilized by a user. In such situations, the transceiver 41 can be configured to complement said existing transceiver system, such as the incorporation of a preprocessor, signal conditioner, active noise canceler and an amplifier. The transceiver 41 may also have a separate telecommunications channel or telephone line/number for translating a foreigner's speech from the channel or line/number for translating a user's speech. As mentioned in an earlier paragraph, the preferred method for adjusting the audio output intensity of the outputted translated speech from the loudspeaker 37 is to use software, firmware, voice command, and/or a combination thereof.

Although one of the main function of the translator or transceiver 41 is for language translation, it should be understood that it can also easily be used for other voice communication applications such as voice recognition (speech-to-text), telephone communications or sending speech signals to a remote command facility 80. It is preferable that the transceiver module 41 be dual-channeled whereby one channel is used for translating the speech of a user and another channel for translating the speech of a foreigner. A transceiver 41 used for language translation may be a separate component or module from the transceiver used for voice communication or recognition, thus utilizing a different frequency or channel but still enclosed or integrated in the same transceiver 41. It is understood that the translation assembly 40 can consist of various modules or components. Quick-disconnect element 43 may be implemented to allow for rapid disconnection or connection of the I/O cable 34 from the transceiver 40. The translation assembly 40 may further comprise circuitry and/or program routines that generate the appropriate anti-noise signals from the speech input captured by an internal microphone 35 or 135, whereby said inverted signals are amplified and therein fed to the loudspeaker 136 producing a suitable output to interfere with the ambient noise.

The speech captured by the internal microphone 35 can also be used to control the output volume of loudspeaker 36 by means of voice-enabled command software. For situations whereby the quality of a speech signal is critical or the speech clarity is vital, a separate or dedicated microphone optimally located inside the mouthpiece 30 may be implemented. An inline mute and volume control component may also be utilized to control the intensities of the earphone's audio output. A potentiometer can also be incorporated on the device 10 to attain a suitable volume of the audio output manually.

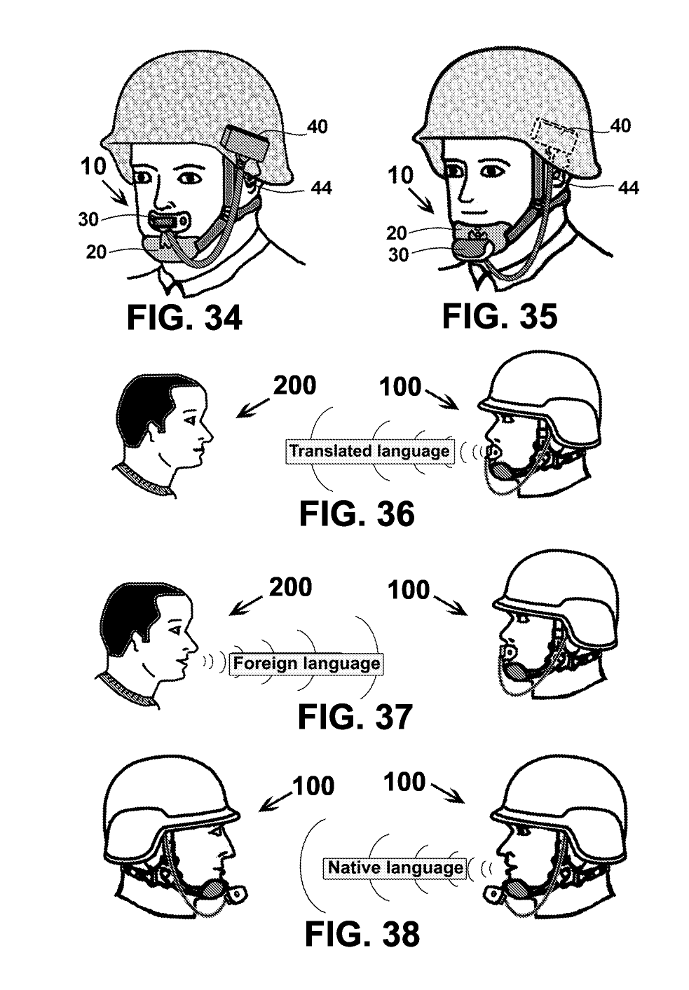

FIG. 34 shows the device 10 being used by a helmeted person for language translation whereby the mouthpiece 30 is swiveled upwards relative to the chin cup 20 and seen covering the user's mouth area thereby preventing some of the unwanted untranslated speech from being heard by a foreigner while the user's speech is captured by the interior microphone 35 to be translated. In this circumstance, device 10 is activated or powered up, causing the user's speech to be translated into a foreigner's language whereby the loudspeaker 36, seen on the exterior of mouthpiece 30, outputs the translated speech for a foreigner to hear. The exterior microphone 37 seen on the front of the mouthpiece 30 captures the speech of a foreigner whereby it is translated and the translated signal is later fed to the earphone 44 for a user to hear. The translator assembly 40 can be mounted securely on a user's helmet or clothing or other parts of his body, either inside or outside, by Velcro tape, hooks, screws, bolts or other mechanical fasteners that allow for generally easy removable of the assembly 40.

FIG. 35 shows the device 10 not being used for language translation whereby the mouthpiece 30 is swiveled downwards relative to the chin cup 20 and seen not covering the user's mouth area thus the user's speech is not muffled nor translated. In this circumstance, the device 10 is deactivated or powered down and the user is able to converse or speak in his native language normally.

FIGS. 36-38 are pictorial representations illustrating in more detail the explanations provided by the previous two paragraphs between a user 100, a foreigner 200, and another user 100. In the first figure or scenario, the user 100 is seen translating his speech by speaking into the internal microphone 35 located inside the mouthpiece 30 that is covering his mouth area preventing the foreigner 200 from hearing his untranslated speech and vocal noise where subsequently said speech is thereinafter translated by a translator 40. The translated speech is then amplified and consequently fed to the loudspeaker 36 producing a suitable output for a foreigner to hear.

In the second figure or scenario, the foreigner 200 is seen speaking into the external microphone 37 located on the exterior of the user's 100 mouthpiece 30 whereby his untranslated speech gets sent to the translator system 40. The translated speech of the foreigner 200 is then conditioned and consequently fed to the earphone 44 producing a suitable output for a user to hear.

In the third figure or scenario, the user 100 is seen speaking to another user 100 but this time the mouthpiece 30 is not covering his mouth area thereby allowing his untranslated or normal speech to be heard by the other user 100.

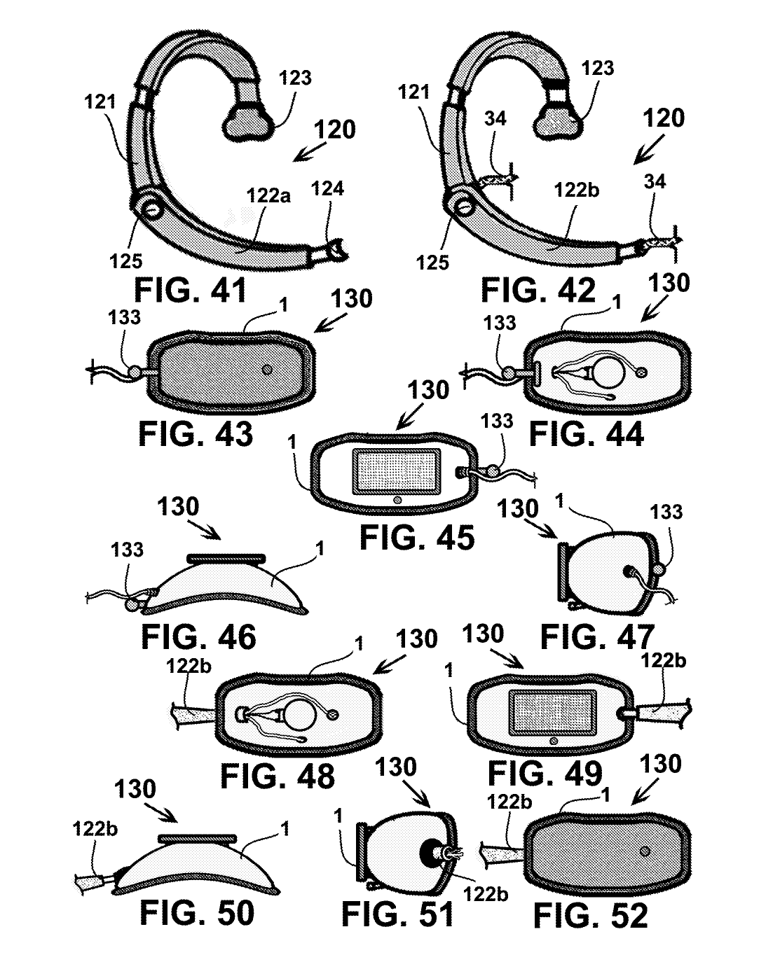

FIG. 39 shows a headset embodiment of the present invention, seen as general reference 110, comprising of three main assemblies, namely: a headband assembly 120; a mouthpiece assembly 130; and a translator assembly 40. A battery pack or compatible power source 190 that is rechargeable, detachable, and/or replaceable can also be implemented for the invention 10 and mounted in proximity with the translator assembly 40. The headband assembly 120, seen in FIG. 41, further comprises an adjustable over-the-head arcuate component 121, a rotating boom component 122a having one end attached to the arcuate unit 121 by a pivot mechanism 125 and the other end having a socket (part of a ball-and-socket unit) or a pivot mechanism 124 that connects to a mouthpiece assembly 130, and a temple pad portion 123 positioned at the other end of arcuate unit 121 to ensure that the assembly 120 stays firmly on a user's head. The socket or pivot unit 124 allows the mouthpiece assembly 130 to swivel and/or rotate generally sideways to cover a user's mouth area effectively. A detent functionality of said mechanism 124 may be implemented to keep the mouthpiece 130 in place during operation and non-operation, preventing assembly 130 from flopping about. Further, the other end of arcuate 121 may be terminated with a structure that can accommodate a second earcup component 144 in place of a temple pad 123. To use the invention 110, the mouthpiece 130 may be made to touch or press lightly against a user's face, covering much of the user's mouth area whereby it can confine or interfere with most of the user's vocal noise.

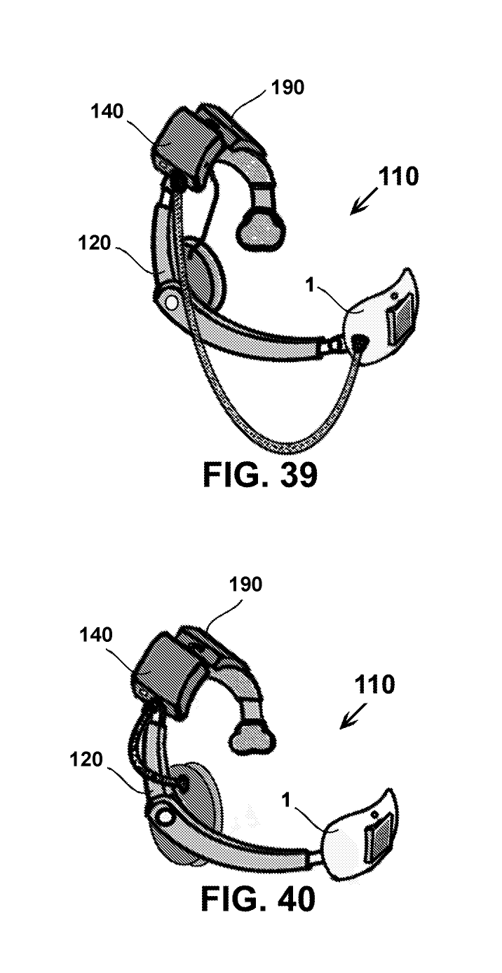

An alternative to the headset embodiment 110 is seen in FIG. 40 which generally comprises of three main assemblies, namely: a headband assembly 120; a mouthpiece assembly 130; and a translator assembly 140 whereby said headband assembly 120, seen in FIG. 42, further comprises an adjustable over-the-head arcuate component 121, a boom component 122b having one end that is somewhat rigid structurally attached to the arcuate unit 121 by a pivot mechanism 125 and the other end having a flexible and/or supple structure that connects to a mouthpiece assembly 130, and a temple pad portion 123 positioned at the other end of arcuate unit 121. Further, flexible boom 122b is generally having a hollow construction to allow the wiring 34 to pass through thereby eliminating a dangling cord, making the device 110 less cumbersome. A similar structure can be seen in a prior art device such as the Motorola X205 gaming/coach's headset. The flexibility of the boom 122b allows the mouthpiece assembly 130 to swivel and/or rotate generally sideways to cover a user's mouth area effectively. Also, the other end of arcuate 121 may be terminated with a structure that can accommodate a second earcup component 144 in place of a temple pad 123. To use the device 110, the mouthpiece 130 may be made to touch or press lightly against a user's face, covering much of the user's mouth area whereby it can confine or interfere with most of the user's vocal noise.

FIG. 43 shows the front elevational view of the mouthpiece assembly 130 for a socket 124 headset embodiment comprising the invention 1 and a ball (part of a ball-and-socket unit) mechanism 133 that corresponds to the headset socket 124. FIG. 44 shows the mouthpiece assembly 130 with the protective foam cover 32 removed thereby showing the ball portion 133 of the ball-and-socket unit attached. Following are the other views illustrating the ball portion 133 starting with the rear view (FIG. 45), the top view (FIG. 46), and the side view (FIG. 47).

FIG. 48 shows the front elevational view of the mouthpiece assembly 130 for a flexible boom 122b headset embodiment comprising the invention 1 and the end portion of the flexible boom, with the protective foam cover 32 removed thereby showing the hollow portion of the flexible boom 122b attached and the wiring 34 going through said hollow portion. Following are the other views demonstrating further the relationship of the flexible boom 122b with regards to the mouthpiece 130 starting with the rear view (FIG. 49), the top view (FIG. 50), the side view (FIG. 51), and the front view of said mouthpiece 130 having a protective cover on (FIG. 52).

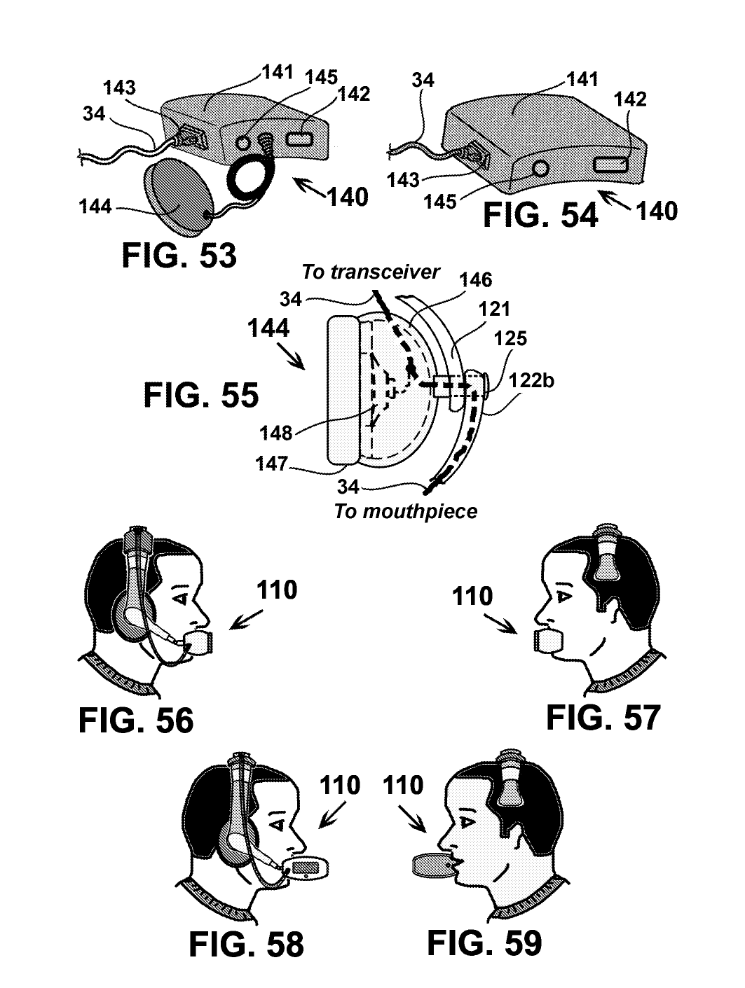

FIG. 53 illustrates a translator assembly 140 for a pivot mechanism 124 embodiment of a headset assembly 110 whereas FIG. 54 shows a translator assembly 140 for a flexible boom 122b embodiment of the headset 110. The translator 140 is generally having a contour shape housing to conform to the arcuate shape of the headband 120 and mounts on the top segment of said headband 120 further comprising an integrated computerized language translator 141 that translates one or more languages into one or more targeted languages and a switch or multi-key 145 to activate or deactivate said translator 141. It can also have additional components such as: an earpiece, earcup or earphone or headphone 144 which allows a user to hear feedback or proofreading data or any audio or a combination thereof; an external battery, battery pack, or similar power source 190 to extend its power capacity; and a cable connector, USB connector or quick-connect adaptor 143 to facilitate the connection or disconnection of the mouthpiece 130 components to the translator 141. The headphone 144 is positioned at the interior portion of the headband 120 adjacent to the pivot 125 such that it would correspond and hold next to the user's ear. A compatible cordless earphone may also be used instead of the corded earphone 144 for user convenience. An earmuff can be used instead of earphone 144 for applications whereby the user prefers not to listen to any audio. A potentiometer or volume control switch 142 can also be incorporated on the translator 141 to attain a suitable volume of the audio output manually. The translated speech is typically generated by converting the user's speech into a desired language by the use of some software technologies such as automatic speech recognition (ASR), machine translation (MT), and text-to-speech synthesis (TTS) employing high speed computer systems. It is a preference of the invention 10 that the translator 141 to be used is fast and powerful, yet small and lightweight.

Alternatively, the translation assembly 140 can comprise an integrated transceiver 141 instead of an integrated standalone computerized translator 141 to allow for remote language translation capability. Using an integrated transceiver 141, a user's speech is transmitted to a remote language translation facility 80 that translates one or more languages into one or more targeted languages, either by human interpreters or by automated machine translators, and then receives the translated speech whereby said speech is conditioned to suitable signal levels that is intelligible to a foreigner. The transceiver 141 also receives a foreigner's speech and sends it to said remote language translation facility 80 whereby the translated speech is conditioned to suitable audio signal that is heard by the user of device 110. The transceiver 141 functionality of the device 110 allows a human translator to be situated thousands of miles away. The transceiver 141 is generally optional if there is already a similar device that is being utilized by a user. In such situations, the transceiver 141 can be configured to complement said existing transceiver system, such as the incorporation of a preprocessor, signal conditioner, active noise canceler and an amplifier. The translation transceiver 141 may also have a separate telecommunications channel or telephone line/number for translating a foreigner's speech from the channel or line/number for translating a user's speech. As mentioned in an earlier paragraph, the preferred method for adjusting the audio output intensity of the outputted translated speech from the loudspeaker 37 is to use software, firmware, voice command, and/or a combination thereof.

Although one of the main function of the translator or transceiver 141 is for voice communications, it can also be used for voice recognition (speech-to-text), digital communications or sending speech signals to a remote language translation facility 80 that translates one or more languages into one or more targeted languages, either by human interpreters or by automated machine translators. The translator or transceiver 141 can also receive the translated speech and then condition said speech to suitable signal levels for intelligibility. It is preferable that the translator or transceiver 141 to be dual-channeled whereby one channel is used for translating the speech of a user and another channel for translating the speech of a foreigner. A transceiver used for language translation may be a separate component or module from the transceiver used for voice communication or recognition, thereby utilizing a different frequency but still enclosed or integrated in the same translator or transceiver 141. Quick-disconnect element 143 may be implemented to allow for rapid disconnection or connection of the I/O cable 34 from the translator or transceiver 141.

One of the other function of the translation assembly 140 is for noise reduction and is achieved by using prior art techniques such as utilizing microphone, amplifier, and loudspeaker components to reduce undesirable soundwaves by feeding back a 180 degree phased (anti-noise) signal of the original soundwaves and causing the signals to cancel each other out. The translation assembly 140 may further comprise circuitry and/or program routines that generate the appropriate anti-noise signals from the speech input captured by the microphone 35, whereby said inverted signals are amplified and therein fed to the loudspeaker 36 producing a suitable output to interfere with the ambient noise.

FIG. 55 is an exploded view of an earpiece or earcup assembly 144 of a flexible hollow boom embodiment of the invention 10 showing the general routing of the cable 34 starting from the translation assembly 140, then through the earcup housing 146 wherein a pair of wires gets connected to the speaker 148. I/O wiring 34 is further routed through the hollow pivot component 125, then through the hollow boom 122b, and finally out to the input/output (I/O) components on the mouthpiece 130. Earmuff or cushion 147 provides the user comfort while wearing the device 110.

FIGS. 56 and 57 are pictorial side views of an embodiment of the invention 1 demonstrating how the device 110, shown with the mouthpiece 130 covering a user's mouth or in the closed position, would look like when it is being used by a typical user. In this position, there will be substantially less vocal noise emitted by the user when he/she speaks and his/her voice is conveyed wirelessly to the intended speech processor.

FIGS. 58 and 59 show pictorial side views of how device 110, shown with the mouthpiece 130 uncovering a user's mouth or in the open position, would look like when it is ‘not used’. In this open position, the device 110 is deactivated, powered down or in standby mode and ambient noise will be heard by others in his/her immediate vicinity when he speaks.

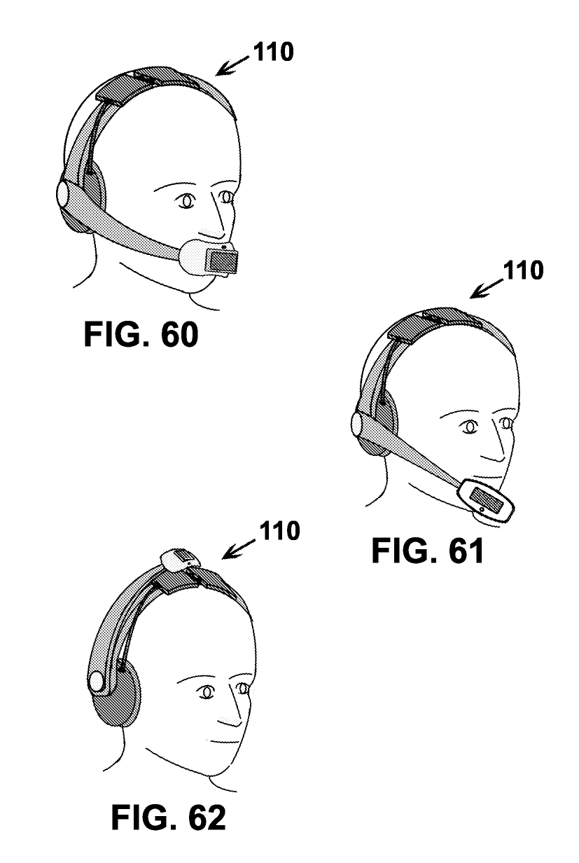

FIGS. 60-62 are perspective pictorial views of various arrangements of a flexible boom embodiment of invention 1. The first view shows the device 110 being used for translating, on the second it is on standby, and the third view shows said device 110 being on a standby/storage arrangement.

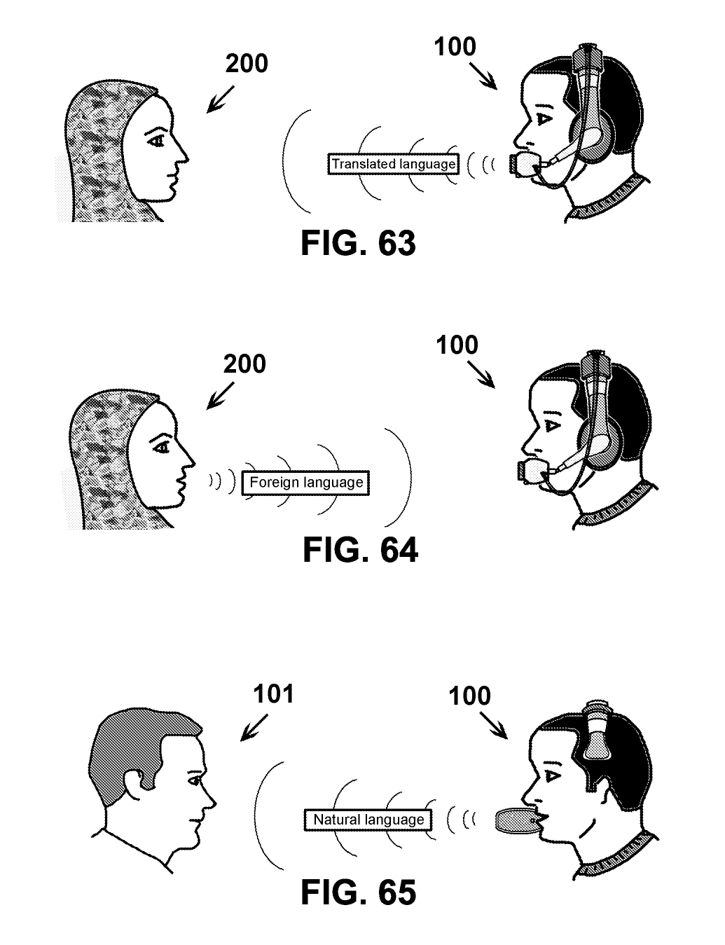

FIGS. 63-65 are pictorial representations illustrating in more detail the typical scenarios provided by the previous paragraphs between a user 100, a foreigner 200, and another user 100. In the first figure or scenario, the user 100 is seen translating his speech by speaking into the internal microphone 35 located inside the mouthpiece 130 that is covering his mouth area preventing the foreigner 200 from hearing his untranslated speech and vocal noise where subsequently said speech is thereinafter translated by a translator 141. The translated speech is then amplified and consequently fed to the loudspeaker 36 producing a suitable output for a foreigner to hear.

In the second figure or scenario, the foreigner 200 is seen speaking into the external microphone 37 located on the exterior of the user's mouthpiece 130 whereby his untranslated speech gets sent to the translator 141. The translated speech of the foreigner 200 is then conditioned and consequently fed to the earphone 144 producing a suitable output for a user 100 to hear.

In the third figure or scenario, the user 100 is seen speaking to another person 101 who speaks the same language and this time the mouthpiece 130 does not cover said user's mouth area thereby allowing his untranslated or normal speech to be heard by the other person 101.

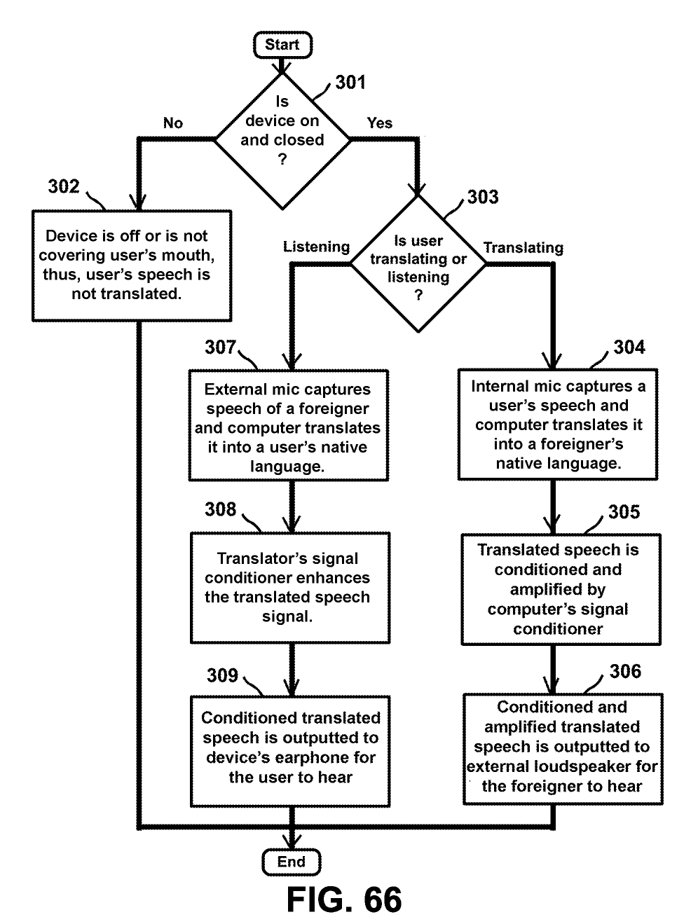

FIG. 66 shows a flowchart diagram of an embodiment of the invention 10/110 summarizing an integrated (local) computerized system 41/141 process for speech-to-speech language translation whereby the process starts by checking to see if user 100 is using the invention 10/110, such as when the mouthpiece 30/130 is swiveled inward covering a user's mouth area or closed (step 301). If the device 10/110 is not being used, i.e., the mouthpiece 30/130 is in an open or swiveled outward arrangement, and is not powered up, then the process is terminated (step 302). If the invention 10/110 is in a standby mode or powered up, then as soon as the mouthpiece 30/130 is closed (covering user's mouth), the internal microphone 35 will be primed to receive and process the speech of a user 100 (step 303). It should be noted that when the device 10/110 is in use, a translating mode (the speech of user 100 is being translated) and a listening mode (the speech of foreigner 200 is being translated) can happen simultaneously (step 303). It is preferred that the translation and listening processes do not happen simultaneously in order to achieve an effective dialogue between the user 100 and the foreigner 200. The default arrangement therefore is that the internal microphone 35 is the only one that will be active initially. After the user 100 issues a command such as “over” then the arrangement reverses and the internal microphone 35 goes dead and the internal microphone 37 goes live. One way of achieving the abovementioned arrangement is through a firmware or software program. However, in situations where full realtime two-way translation is desired, an alternative method such as using separate frequencies, telephone lines, or channels for the two translation processes can be implemented. For example, the translator 141 may use channel 1 for translating the speech of the user 100 and channel 2 for translating the speech of the foreigner 200. This means that while the user 100 is speaking and thereby having said speech getting translated, the foreigner 200 can also be speaking and having his speech getting translated simultaneously.

In the translating mode, the user 100 speaks into the microphone 36 located inside the mouthpiece 30/130 whereupon his speech is translated by the translator 141 (step 304). The user 100 may use or say the word “over” (or something similar) to command the translator 41/141 that he now wants his sentence to be translated. This can also allow the translator 41/141 to disable the microphone 35 and enable the microphone 37.

A short while thereafter, the translator 141 produces and amplifies the translated speech (step 305).

The final step of the translation mode further includes the process whereby the amplified translated speech signal gets fed to an external loudspeaker 37 positioned on the exterior of the mouthpiece 30/130 producing an audible output for a foreigner 200 to hear the translation (step 306).

In the listening mode, the foreigner 200 speaks in the general direction of the user or device 10/110, specifically towards microphone 37 located on the exterior of mouthpiece 30/130, whereby the speech of the foreigner 200 is captured and thereupon gets translated by the language translator 141 (step 307).

A short while thereafter, although at times almost instantaneously, the language translator 141 produces the translated speech and conditions said translation signal (step 308).

As a final step in the listening mode, the processed or conditioned translated speech signal is outputted to an earphone 44/144 thereby allowing the user 100 to hear the translated speech of the foreigner 200 (step 309). The user 100 may then use or say the word “understand” (or something similar) to inform the translator 41/141 that he's clear about what the foreigner was conveying and thus wants the circuitry of the translator 41/141 to disable the external microphone 37 and enable the internal microphone 35.

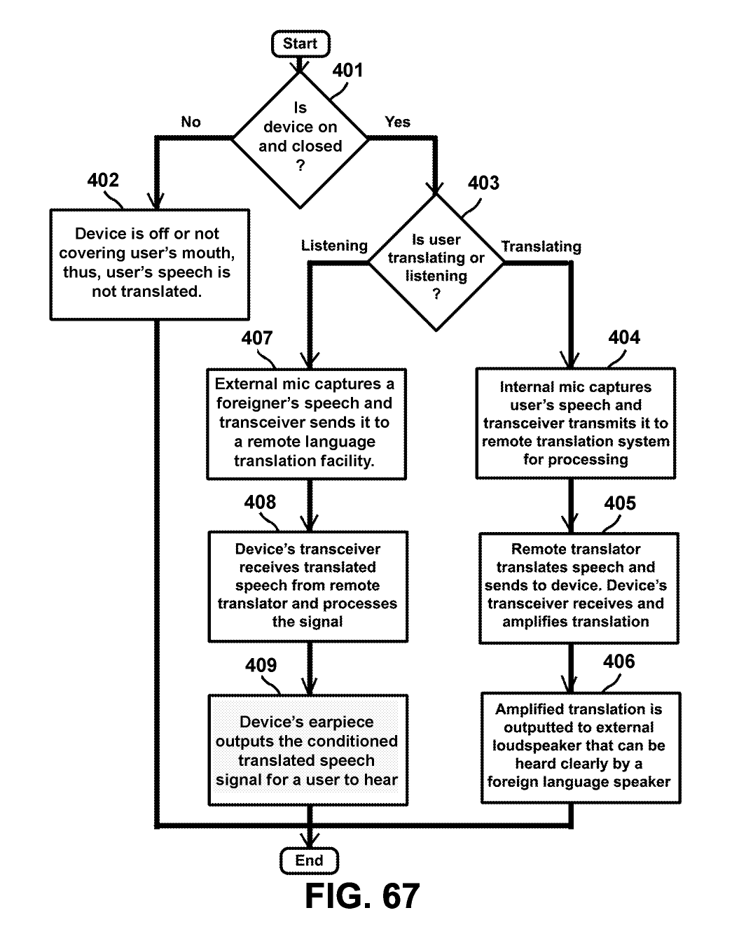

FIG. 67 shows a flowchart diagram of an embodiment of the invention 10/110 summarizing a transceiver 41/141 process for speech-to-speech remote language translation whereby said process starts by checking to see if user 100 is using the invention 10/110, such as when the mouthpiece 30/130 is swiveled upward covering a user's mouth area or closed (step 401). If the device 10/110 is not being used then the mouthpiece 30/130 is generally in an open or swiveled down arrangement and is either on a standby mode or completely powered down (step 402). If invention 10/110 is in a standby mode, then as soon as the mouthpiece 30/130 is closed (covering user's mouth), the internal microphone 35 will immediately be able to receive and process the speech of the user 100 for translation by the language translator 141. Further, when said device 10/110 is in-use, a translating mode (the speech of user 100 is being translated) and a listening mode (the speech of foreigner 200 is being translated) can happen simultaneously (step 403) since both internal 35 and external 37 microphones are active at this juncture. It is preferred however that the translation and listening modes do not happen simultaneously in order to achieve an effective dialogue between the user 100 and the foreigner 200.

In the translating mode, the user 100 speaks into the microphone 35 located inside the mouthpiece 30/130 whereupon his speech is transmitted by the transceiver 141 to a remote language translation system 80 either via base station 70 directly or by way of a wireless headset 50 or by way of a mobile phone 60 or a USB dongle 70 or another RF transceiver 70 or any combination thereof (step 404).

A short while thereafter, the language translation system 80 produces the translated speech and sends it to the device 10/110 whereby the transceiver 141 receives and amplifies said translation (step 405).

The final step includes the process whereby the amplified translated speech signal gets fed to an external loudspeaker 36 positioned on the exterior of the mouthpiece 30/130 producing an audible output for a foreigner 200 to hear the translation (step 406).

In the listening mode, the foreigner 200 speaks in the general direction of the device 10, specifically towards microphone 37 located on the exterior of mouthpiece 30/130, whereby the speech of the foreigner 200 is captured and thereupon gets transmitted by the transceiver 141 to a remote language translation system 80 by way of a wireless base station 70 or a wireless headset 50 or a mobile phone 60 or a combination thereof (step 407).

A short while thereafter, although at times almost instantaneously, the language translation system 80 produces the translated speech and sends it to the device 10/110 whereby the transceiver 141 receives and processes said translation signal (step 408).

As a final step in the listening mode, the processed translated speech signal is outputted to an earphone 44/144 connected to a transceiver 141 thereby allowing the user 100 to hear the translated speech of the foreigner 200 (step 409).

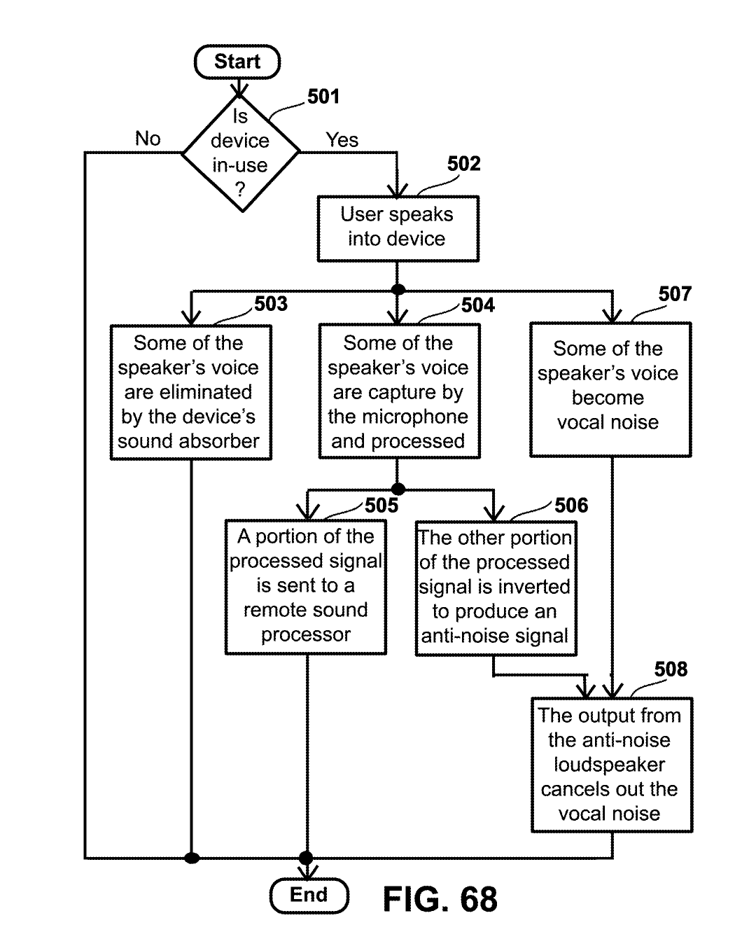

FIG. 68 shows a flowchart diagram of the anti-noise cancellation process of an embodiment of the invention 1 whereby the device 10/110 is first checked if it is in an in-use status (event 501). If it is, then the user operates the invention 1 by speaking into the mouthpiece 10/110 (event 502). If not, then the process is ended. The soundwaves from the user's voice that are generated by such processes, for purposes of simplification, can be demonstrated as generally dispersing into 3 different pathways.

The first pathway points out that some of the soundwaves are eliminated by the sound absorbers 32 embedded in the mouthpiece 30/130 (event 503). Event 504 shows some of the soundwaves being captured by microphone 35 are processed and split into two signals, one signal is converted into radio waves and sent to remote sound processors by the transceiver 141 (event 505), and the other signal is reverse phased to produce the output that loudspeaker 136 generates as the anti-noise wave (event 506). The third set of soundwaves, shown in event 507, are dispersed in the user's immediate vicinity and become unwanted sound or referred to as vocal noise. Finally, in event 508, this vocal noise is interfered by the anti-noise wave generated in event 506 causing them to cancel each other out and become faint or inaudible.

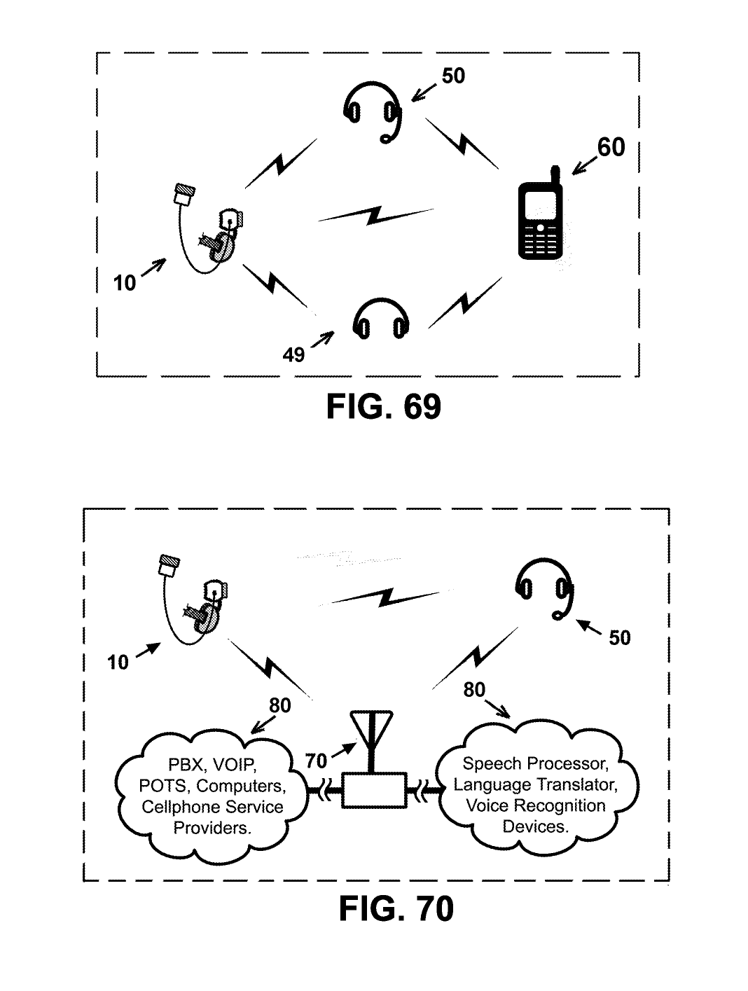

FIG. 69 shows a diagram of a helmet 10 embodiment of the invention 1 whereby the integrated transceiver 41/141 is telecommunicating with either a mobile phone 60 or with a wireless headset 50 or with a cordless earphone 49 or a combination thereof. The device 10 also sends and/or receives other wireless signals such as control, monitoring, and/or management data from a mobile phone 60 or a headset 50 or a combination thereof. The mobile phone 60 generally connects to a cellphone service provider such as Verizon or AT&T which can provide translation services, and other vendors such as Interpreters Unlimited which provide telephone interpretation services. A user of invention 1 may also telecommunicate with a device having the functionalities of a wireless headset 50 or another compatible device 10.

FIG. 70 shows a diagram of a helmet 10 embodiment of the invention 1 telecommunicating with a wireless headset 50 or a wireless base station unit 70 or a RF transceiver station 70 that connects to a system 80 that further connects to subsystems such as a PC, a computer file server, a video processing system, a voice recognition system, a cellphone service provider, an automatic language translation system, a human interpreter, a telephone interpreter service, a machine translator, TELCO, POTS, a transcription machine, other voice input processors and/or a combination thereof. The device 10 can also receive wireless signals such as voice commands, test signals, control signals, video signals, monitoring and management signals from other systems 80 through base station or transceiver 70 or a headset 50 or a combination thereof.

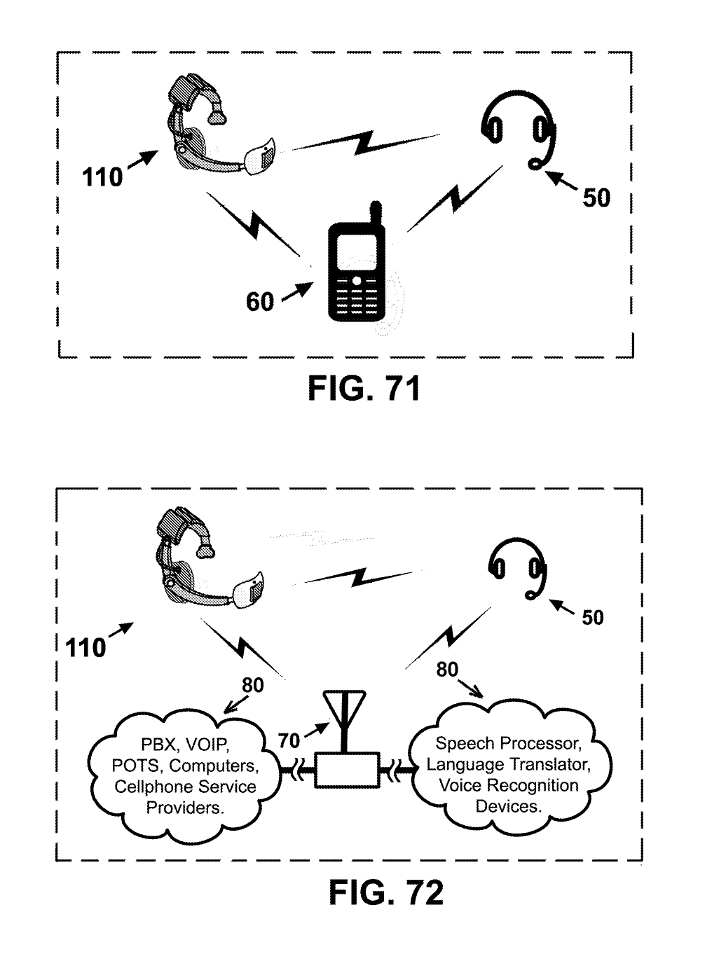

FIG. 71 shows a diagram of a headset 110 embodiment of the invention 1 whereby the integrated transceiver 41/141 is telecommunicating with either a mobile phone 60 or with a wireless headset 50 or with a cordless earphone 49 or a combination thereof. The device 110 also sends and/or receives other wireless signals such as control, monitoring, and/or management data from a mobile phone 60 or a headset 50 or a combination thereof. The mobile phone 60 generally connects to a cellphone service provider such as Verizon or AT&T which can provide translation services, and other vendors such as Interpreters Unlimited which provide telephone interpretation services. A user of invention 1 may also telecommunicate with a device having the functionalities of a wireless headset 50 or another compatible device 110.

FIG. 72 shows a diagram of a headset embodiment of the invention 1 telecommunicating with a wireless headset 50 or a wireless base station unit 70 or a RF transceiver station 70 that connects to a system 80 that further connects to subsystems such as a PC, a computer file server, a video processing system, a voice recognition system, a cellphone service provider, an automatic language translation system, a human interpreter, a telephone interpreter service, a machine translator, TELCO, POTS, a transcription machine, other voice input processors and/or a combination thereof. The device 10 can also receive wireless signals such as voice commands, test signals, control signals, video signals, monitoring and management signals from other systems 80 through base station or transceiver 70 or a headset 50 or a combination thereof.

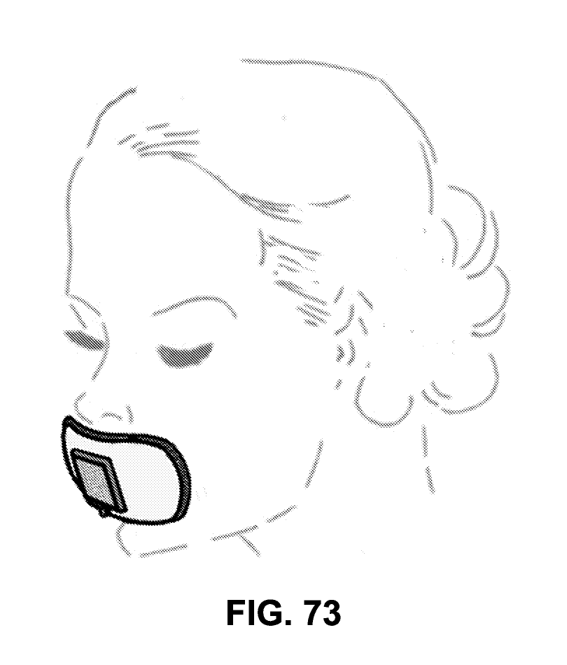

FIG. 73 shows the invention covering a user's mouth area without a headset, a helmet, or other structure supporting it to illustrate the device's positional correlation to the user when it is being used.

I claim:

1. A speech muffled language translation device comprising a contour shaped hollow housing having a closed end and a wide-open end, said housing further comprising:
a primary microphone to capture a user's speech
and a loudspeaker to output a translated speech to a person other than the user of said device.

2. The speech muffled language translation device according to claim 1 wherein said housing further comprises a secondary microphone positioned on the exterior of said housing to capture a speech of a person other than the user of said device.

3. The speech muffled language translation device according to claim 1 wherein said housing is connected to a transceiver positioned at a suitable distance from said housing.

4. The speech muffled language translation device according to claim 1 wherein said housing further comprises a formable interior housing that reduces noise.

5. The speech muffled language translation device according to claim 1 wherein said housing further comprises a vent to allow pressurized air within said housing to escape to the outside.

6. The speech muffled language translation device according to claim 1 wherein said housing further comprises a supple material conforming to the brims of said housing associated with a user's mouth area.

7. The speech muffled language translation device according to claim 1 wherein said housing further comprises a sensor or switch, or a combination thereof, associated with said transceiver.

8. A speech muffled language translation device comprising a contour shaped hollow housing having a closed end and a wide open end, said housing further comprising:
a primary microphone to capture a user's speech;
a loudspeaker to output a translated speech to a person other than the user of said device;
and a secondary microphone positioned on the exterior of said housing to capture a speech of a person other than the user of said device.

9. The speech muffled language translation device according to claim 8 wherein said housing is connected to a transceiver positioned at a suitable distance from said housing.

10. The speech muffled language translation device according to claim 8 wherein said housing further comprises a formable interior housing that reduces noise.

11. The speech muffled language translation device according to claim 8 wherein said housing having a means for varying the input or output signals to or from said transceiver.

12. The speech muffled language translation device according to claim 8 wherein said housing further comprises a supple material conforming to the brims of said housing associated with a user's mouth area.

13. The speech muffled language translation device according to claim 8 wherein said housing further comprises a sensor or switch, or a combination thereof, associated with said transceiver.

14. A speech muffled language translation device comprising a hollow housing having a closed end and a wide open end wherein the closed end having a contour shape, said housing further comprising:
a primary microphone to capture a user's speech;
a loudspeaker to deliver a translated speech to a person other than the user of said device;
a secondary microphone to capture the speech of a person other than the user of said device;
and a transceiver connected to said housing for processing, transmitting and receiving signals.

15. The speech muffling language translation device according to claim 14 further comprising an earphone associated with said transceiver to output a translated speech to the user of said device.

16. The speech muffled language translation device according to claim 14 wherein said housing further comprises a supple material conforming to the brims of said housing associated with a user's mouth area.

17. The speech muffled language translation device according to claim 14 wherein said interior housing is removable.

18. The speech muffled language translation device to according to claim 14 wherein said housing having a means for varying the input or output signals to or from said transceiver.

19. The speech muffled language translation device according to claim 14 wherein said housing further comprises a sensor or switch, or a combination thereof, associated with said transceiver.

20. The speech muffled language translation device according to claim 14 further comprising a sensor or electronic circuitry for activating or deactivating said device associated with said transceiver.
